(19) United States
(12) Patent Application Publication
(10) Pub. No.: US 2016/0092903 A1
(43) Pub. Date: Mar. 31, 2016

(54) SYSTEMS AND METHODS FOR CREATING A CONSUMER ENVIRONMENTALLY AWARE PRODUCT

(71) Applicants: Sebastiaan A.M. Fransen, Midlevels (HK); Raymond Davids, Yogyakarta (ID)

(72) Inventors: Sebastiaan A.M. Fransen, Midlevels (HK); Raymond Davids, Yogyakarta (ID)

(21) Appl. No.: 14/501,589

(22) Filed: Sep. 30, 2014

(51) Int. Cl. G06Q 30/02; G06Q 50/26

(52) U.S. Cl. CPC G06Q 30/0226; G06Q 30/0279; G06Q 50/26

(57) ABSTRACT

A method for incentivizing ecological awareness is disclosed. The method includes providing a consumer device; marking the consumer device with a unique identifier; and linking the unique identifier to an environmental asset.

### BACKGROUND

In today's consumer market, whether it is electronics or non-electronics related, some companies have initiated programs to highlight their sustainability efforts. Examples include Apple with its Red program, whereby Apple gives a portion of the purchase price of Red products to the Global Fund to fight AIDS in Africa. Another example is TOMS with its One-for-One program where with every product that is purchased, TOMS will help a person in need. Reveal claims that for every product sold in its Nature Tech Collection, it will donate proceeds to the non-profit American Forests which will plant a tree on the customer's behalf.

Although they are all worthy initiatives, they lack details on the recipient of the give back. For example, with TOMS the consumer does not know what pair of shoes is donated and to whom. With Reveal, the consumer does not know the location of the tree planted on the consumer's behalf.

The present disclosure is directed at overcoming one or more of the above deficiencies.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a conceptual overview of an exemplary embodiment consistent with the present invention in its functional setting.

FIG. 2 is an exemplary flowchart of an embodiment consistent with the present invention.

FIG. 3 is an exemplary flowchart of a tree planting and recording process consistent with the present invention.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The present disclosure is directed at systems and methods for improving existing sustainability programs by linking a consumer device to a specific environmental asset, such as a tree, that has been planted and purchase in association with the consumer device. As an example, a user may purchase a case for a mobile phone. The case will be engraved with an unique identifier associated with a particular tree whose planting has been paid for with revenue from the sale of the case. The user may look up the unique identifier on a web site to find the specific location of the tree. This may be displayed on a map for the user. Thus, the user is given the feedback of seeing the actual beneficial good of his purchase of the case. In an exemplary embodiment, the case itself is made from recycled materials, thus further enhancing the sustainability of limited resources.

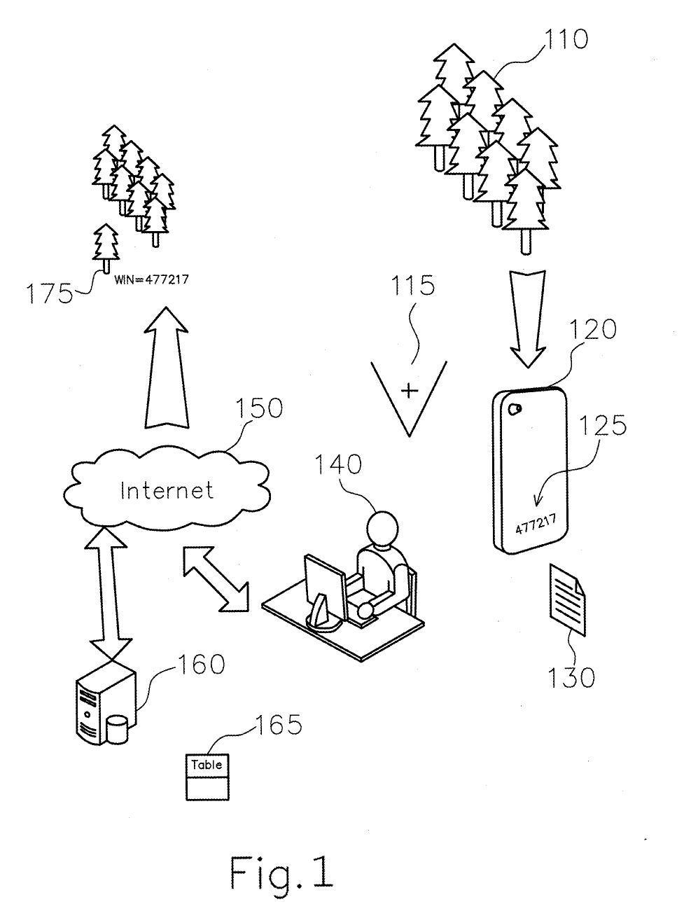

FIG. 1 is a conceptual overview of an exemplary embodiment consistent with the present invention in its functional setting. An environmental asset, such as trees 110, may be used to manufacture a consumer device 120. The environmental asset may be an at-risk environmental resource. The IUCN Red List of Threatened Species lists over 1500 species of threatened trees that would qualify as at-risk environmental resources. The consumer device 120 may also be manufactured using recycled materials.

In one embodiment consistent with the present invention, the consumer device 120 is manufactured from recycled teak wood from boats or houses. The consumer device 120 may be, for example, a case for a portable electronic device, the electronic device itself, furniture, clothing, bags, docking stations, phone stands, and tablet stands. Those of ordinary skill in the art, after reading the present disclosure, will appreciate the wide range of devices that are consumer devices, and the aforementioned list is not intended to be exhaustive.

Once the consumer device 120 is manufactured, or during the manufacturing process itself, a unique identifier 125 is engraved by an engraving machine 115 on the consumer device 120. While the term “engraving machine” and “engraved” is used throughout this specification and claims, the term should be given broad enough scope to include other methods and systems for affixing the unique identifier 125 onto consumer device 120. For example, “engraving” may include printing the unique identifier 125 on the consumer device 120 with a printer or may include carving the unique identifier 125. In embodiments of the present invention engraver 115 may laser or aluminum engrave the unique identifier 125 into the consumer device 125.

In an embodiment of the present invention, the unique identifier 125 is a 6-7 digit number known as a World Identification Number (“WIN”). The WIN represents the environmental resource, such as a tree, that is associated with the consumer device 120. Also provided to the purchaser 140 of the consumer device is a three digit Tree Verification Code (“TVC”) 130.

Purchaser 140 may use a computer with a display and an Internet browser, for example, or an app or specially tailored program, to enter the WIN and the TVC; the purchaser 140 will be provided with a specific location of the environmental asset or tree 175. In an exemplary embodiment consistent with the present invention, the purchaser 140 uses the World Wide Web over the Internet 150 to access a server and database 160. The database 160 includes a table 165 that includes a Keyhole Markup Language (“KML”) file that associates the specific environmental asset 175 with the WIN and TVC. Those skilled in the art should be familiar with KML files, as they are used by Google Maps and Google Earth to overlay information on a Google Map. In the exemplary embodiment accessing the database and KML file will provide the user with a Google Map and specific location of environmental asset 175. Further information on KML files may be found at https://developers.google.com/kml/. While the use of a combination of WIN and TVC serves to lookup the location information of the environmental asset, in certain embodiments, the unique identifier 125 may be used without additional information in order to perform the lookup.

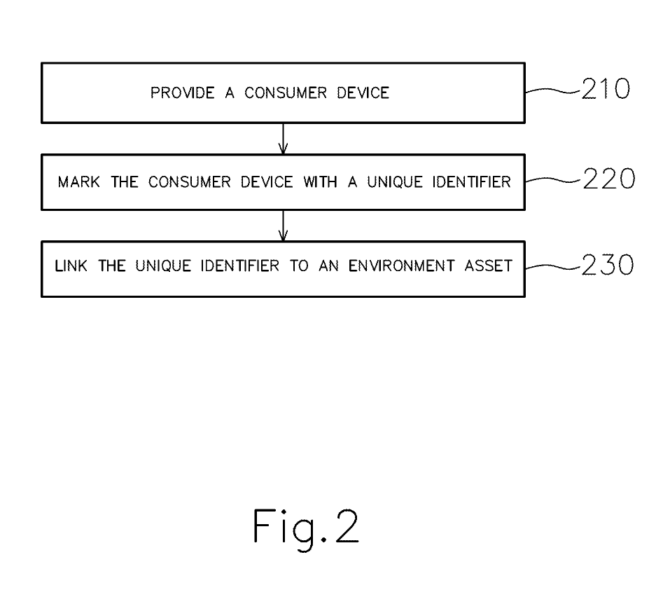

FIG. 2 is an exemplary flowchart of an embodiment consistent with the present invention. Each of the terms used in this description should have the same meaning as described when discussing FIG. 1. In an exemplary method, a consumer device is provided (stage 210). The consumer device is then marked with a unique identifier by an engraving machine (stage 220). The unique identifier is linked with an environmental resource in a database (stage 230). The order of the above stages is not required. For example, the unique identifier may be linked with the environmental resource (stage 230) prior to marking the consumer device with the unique identifier (stage 220).

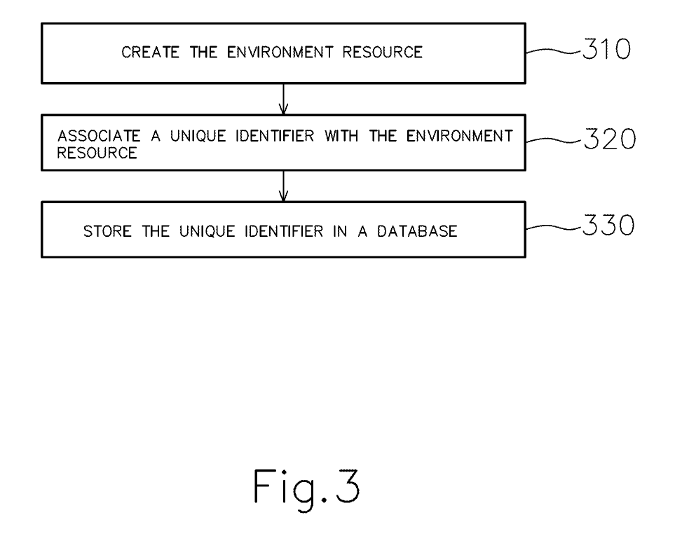

In order for a user to be able to look up the location of the environmental resource, such as a tree, the database must be created linking the environmental resource to the unique identifier. FIG. 3 is an exemplary flowchart of a tree planting and recording process consistent with the present invention. The environmental resource must be initially created or established, e.g., the tree needs to be planted (stage 310). Next, a unique identifier needs to be created that is associated with the environmental resource (stage 320). The unique identifier is stored in a database long with the specific location of the environmental resource (stage 330).

In the previous exemplary embodiments reference is made to establishing the environmental resource, or planting the tree. It may not be particularly efficient to trigger the planting of a tree each time a consumer purchases the consumer product. Instead, in certain embodiments of the invention, a plurality of environmental resources are created at the same time, e.g., a field of trees is planted at regular intervals. The provider of the environmental resource need not be the same entity as the manufacturer, distributor, or seller of the consumer device. For example, in an embodiment of the invention, an organization known as trees4trees (T4T) seen at www.trees4trees.org is responsible for the planting of the trees, while another organization is responsible for maintaining the database, engraving the unique identifier on the consumer device, and selling the consumer device. Trees, or environmental resources, planted as part of the invention may have been planted within one year of the sale date of the consumer device, with the payment also made in advance of the sales.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method for incentivizing ecological awareness, comprising:
providing a consumer device;
marking the consumer device with a unique identifier; and
linking the unique identifier to an environmental asset.

2. The method of claim 1, wherein the environmental asset is an at-risk environmental resource.

3. The method of claim 2, wherein the at-risk environmental resource is a tree.

4. The method of claim 2, wherein the tree is a newly-planted tree.

5. The method of claim 1, wherein marking the consumer device includes engraving the consumer device with the unique identifier.

6. The method of claim 1, further comprising creating a data table linking the unique identifier to the environmental asset.

7. The method of claim 1, further comprising displaying to a purchaser of the consumer device the location of the environmental asset.

8. The method of claim 7, wherein displaying includes using a KML-file (Keyhole Markup Language) to display the environmental resource on a map to the purchaser of the consumer device.

9. The method of claim 4, wherein the tree has been planted within the last year and is purchased by the provider of the consumer device.

10. The method of claim 1 wherein providing a consumer device comprises providing a consumer device made of recycled materials.

11. The method of claim 10 wherein linking comprises linking the consumer device to an environment asset which is the same material as the recycled materials.

12. A system for encouraging environmental awareness comprising:
a marker for marking a consumer device with a unique identifier;
a database for linking the unique identifier to an at-risk environmental resource; and
a display in communication with the database for displaying the location of the at-risk environmental resource to an end-purchaser of the consumer device.

13. The system of claim 12, wherein the at-risk environmental resource is a tree.

14. The system of claim 13, wherein the system further comprises a trigger for purchasing the tree from a newly planted stand of trees.

15. The system of claim 12, wherein the database further comprises a KML-file (Keyhold Markup Language) linking the at-risk environmental resource to a geolocation of the at-risk environmental resource.

16. The system of claim 12, wherein the marker engraves the consumer device with the unique identifier.

17. The system of claim 12, wherein the consumer device is made from the at-risk environmental resource.

18. The system of claim 17, wherein the consumer device is a case for a portable electronic consumer device.

19. The system of claim 17 wherein the consumer device is selected from the group consisting of furniture, clothing, bags, docking stations, phone stands, and tablet stands.

20. The system of claim 19 wherein the consumer device is further made from recycled material.
